(19) United States
(12) Patent Application Publication
(10) Pub. No.: US 2011/0188470 A1
(43) Pub. Date: Aug. 4, 2011

(54) HANDLING MOBILE TERMINATED CIRCUIT-SWITCHED CALLS USING AN 802.21 MEDIA INDEPENDENT HANDOVER (MIH) FRAMEWORK

(75) Inventors: Guang Lu, Montreal (CA); Shamim A. Rahman, Cote St. Luc (CA); Ulises Olvera-Hernandez, Kirkland (CA)

(73) Assignee: INTERDIGITAL PATENT HOLDINGS, INC., Wilmington, DE (US)

(21) Appl. No.: 13/000,290

(22) PCT Filed: Jun. 16, 2009
(86) PCT No.: PCT/US2009/047506

§ 371 Date: Apr. 18, 2011

Related U.S. Application Data
(60) Provisional application No. 61/074,412, filed on Jun. 20, 2008.

(51) Int. Cl. H04W 36/00

(52) U.S. Cl. 370/331

(57) ABSTRACT

A Media Independent Handover (MIH) server communicates with nodes in a cellular network to perform handover of a wireless transmit/receive unit (WTRU) in the event of an incoming circuit-switched (CS) call. A Gateway Mobile Switching Center (GMSC) and/or Home Location Register (HLR) receive an indication of an incoming call, and may communicate with the MIH server. A determination is made regarding whether the WTRU is active in the cellular network. When required, the MIH server initiates an MIH handover of the WTRU to the cellular network. The WTRU hands over to the cellular network and receives the call. Additionally, an MIH server and a HLR communicate location information associated with a WTRU. The location information may be used by the MIH server and HLR to perform their respective MIH and HLR functionality, and/or to handover the WTRU to a cellular network in the event of an incoming CS call.

### TECHNICAL FIELD

This disclosure relates to wireless communications.

### BACKGROUND

Some wireless technologies, such as Institute of Electrical and Electronics (IEEE) 802.11 and 802.16, provide only packet-switched (PS) domain services. Other wireless technologies, including many cellular technologies, provide both a PS and a circuit-switched (CS) domain. Although recent trends indicate a movement in favor of PS technologies, extensive CS infrastructure is already in place and can still be effectively utilized. To protect investments and provide better services to end users, a number of approaches have been developed to improve coordination between PS and CS services, such as the Third Generation Partnership Project (3GPP) CS Fallback and Voice Call Continuity (VCC) technologies.

3GPP CS Fallback specifies a mechanism for using a CS network to provide voice services while using a Long Term Evolution (LTE) network for PS services. According to CS Fallback, a wireless transmit/receive unit (WTRU) may transition to a network such as a Global System for Mobile Communications (GSM) EDGE Radio Access Network (GERAN) or a Universal Mobile Telecommunications System (UMTS) Radio Access Network (UTRAN) to receive a voice call, and then later transition back to the PS LTE network.

According to CS Fallback, a WTRU originates a call by sending a Service Request message including a CS fallback indicator to a mobile management entity (MME) in the LTE network. The MME sends an Initial UE Context Setup message to indicate an eNodeB serving the WTRU to move the WTRU to a target network that includes a CS domain. The WTRU then transitions to the target network. Active PS sessions are also handed over from the LTE network to the PS domain in the target network.

To terminate a CS Fallback call at the WTRU, a mobile switching center (MSC) sends a CS call paging message to the WTRU. In response to the paging message, the WTRU sends a Service Request message including a CS fallback indicator to the MME. The MME then sends a CS Page Reject message to the MSC, and indicates to the eNodeB to transition the WTRU to a target network that includes a CS domain. After entering the CS domain, the WTRU can receive the call. While CS Fallback is effective in transitioning the call to the CS domain, it may result in significant call-handling delay because the paging message must first go the WTRU.

3GPP VCC defines network architecture that allows a WTRU to transition between different radio access networks while maintaining a voice session. The VCC architecture includes a VCC application server in the WTRU's home network and a VCC client application at the WTRU. VCC calls are anchored in the PS domain in an Internet Protocol Multimedia Subsystem (IMS). As a WTRU attaches and detaches from various radio access networks, the VCC client application notifies the VCC application server of changing radio conditions. The voice call path may be transferred between CS and PS call legs when necessary, transparently to the end user.

The IEEE 802.21 Media Independent Handover (MIH) standard defines a framework for supporting mobility of devices between networks based on heterogeneous radio access technologies. MIH defines mechanisms for handover and link adaptation in response to changing link conditions and quality of service (QoS) requirements. MIH specifies an MIH Function (MIHF), which is an implementation of MIH services and is treated as a logical entity implemented in MIH WTRUs and in the network. The MIHF implements three MIH services: the Media Independent Event Service, the Media Independent Information Service (MIIS), and the Media Independent Command Service (MICS). The Media Independent Event service relates to the notification of events such as physical, data link and logical link layers state changes and establishment and tearing down of links. The MIIS provides a mechanism for the exchange of information between MIH devices and MIH-capable networks regarding handover candidates. The MICS provides a media-independent interface for upper layers to issue handover-related commands to lower layers.

While CS Fallback and VCC provide solutions for transferring calls between CS and PS domains, they possess a number of limitations. CS Fallback, for example, is specific to LTE/UTRAN/GERAN systems, and VCC requires the deployment of an IMS. And while MIH supports mobility of WTRUs between heterogeneous networks, its current functionality is directed only at transitions between PS domains. Therefore, new technology is required for supporting transitions from PS to CS domains for voice services in the context of a wide variety of radio access technologies. Additionally, new technology is required that addresses performance issues in current radio access networks, such as significant call handling delays for mobile-terminated calls.

### SUMMARY

An MIH server communicates with nodes in a cellular network to facilitate handover of a wireless transmit/receive unit (WTRU) in the event of an incoming circuit-switched (CS) call. A Gateway Mobile Switching Center (GMSC) and/or Home Location Register (HLR) receive an indication of an incoming CS call, and may communicate with the MIH server. A determination is made as to whether the WTRU is active in the cellular network. When required, the MIH server initiates an MIH handover of the WTRU to the cellular network. The WTRU hands over to the cellular network and receives the call in the CS domain.

Additionally, an MIH server and a HLR may communicate location information associated with a WTRU. The location information may be used by the MIH server and HLR to perform their respective MIH and HLR functionality, and/or to handover the WTRU to a cellular network in the event of an incoming CS call.

### BRIEF DESCRIPTION OF THE DRAWINGS

A more detailed understanding may be had from the following description, given by way of example in conjunction with the accompanying drawings wherein:

FIG. 1 shows an example wireless communication system that facilitates communication between an MIH server, a HLR, and the circuit-switched domain of a cellular network;

FIG. 2 shows a method wherein an MIH server provides location information to an HLR in response to an MIH information request from a WTRU;

FIG. 3 shows a method wherein an MIH server provides location information to an HLR in response to a registration or handover by a WTRU;

FIG. 4 shows a method wherein an HLR provides location information to an MIH server;

FIG. 5 shows a method wherein a GMSC communicates with an MIH server to handover a WTRU to receive a circuit-switched call;

FIG. 6 shows a method wherein an HLR communicates with an MIH server to handover a WTRU to receive a circuit-switched call; and

FIG. 7 shows a method wherein an MIH server includes paging information in an MIH message to page a WTRU to receive a circuit-switched call.

### DETAILED DESCRIPTION

When referred to herein, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, an Evolved Node-B (eNodeB), a site controller, an access point (AP), or any other type of interfacing device capable of operating in a wireless environment.

When referred to herein, the term “processor” includes but is not limited to a single-core or multi-core general purpose processor, a special purpose processor, a conventional processor, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine. When referred to hereafter, the term “computer-readable storage medium” includes but is not limited to a register, a cache memory, a read-only memory (ROM), a semiconductor memory device such as a Dynamic Random Access Memory (D-RAM), Static RAM (S-RAM), or other RAM, a magnetic medium such as a flash memory, a hard disk, a magneto-optical medium, an optical medium such as a CD-ROM, a digital versatile disk (DVDs), or Blu-Ray disc (BD), other volatile or non-volatile memory, or other type of device for electronic data storage. When referred to hereafter, the term “memory device” is a device configurable to read and/or write data to/from one or more computer-readable storage media. The term “database” as used herein means an organized body of data stored in one or more memory devices. A database may be one or more flat files, spreadsheets, structured files, a relational database managed accessible via a relational database management system (RDBMS), or any other type of organized data.

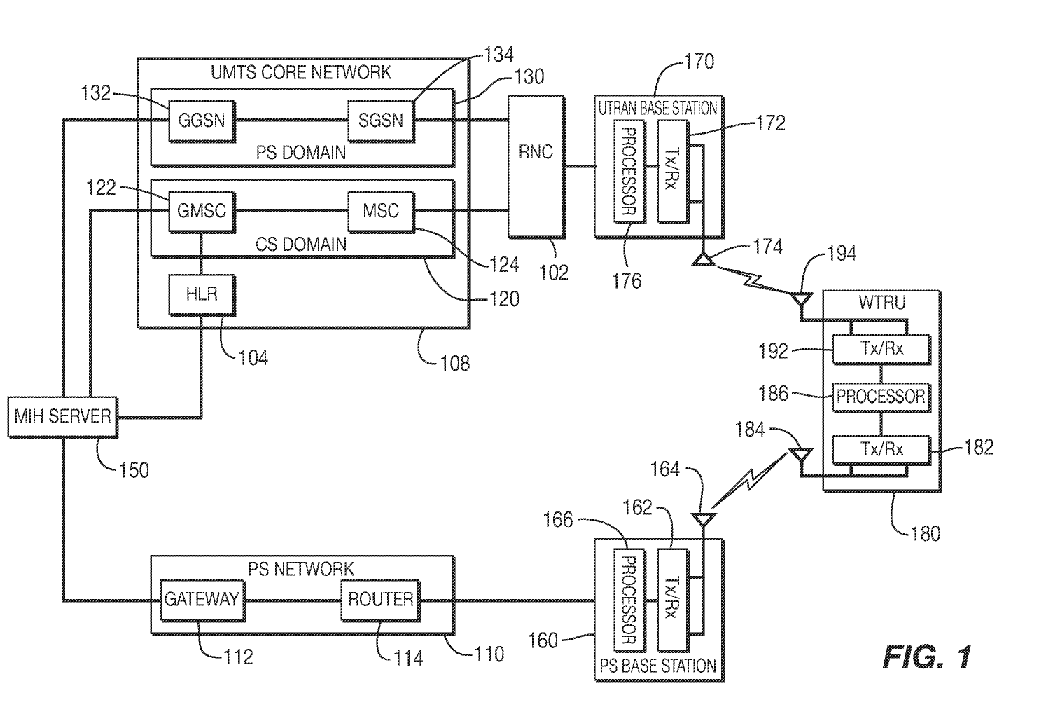

FIG. 1 is an example wireless communication system that facilitates communication from a MIH server 150 to a Home Location Register (HLR) 104 and a Gateway Mobile Switching Center (GMSC) 122. Universal Mobile Telecommunications System (UMTS) core network 108 includes a CS domain 124 and a PS domain 130. The CS domain 120 includes a Gateway Mobile Switching Center (GMSC) 122, which is in communication with a Mobile Switching Center (MSC) 124 and the MIH server 150. The GMSC 122 is also connected to a Public Switched Telephone Network (PSTN) (not depicted).

The packet-switched (PS) domain 130 includes a Gateway General Packet Radio Service (GPRS) Support Node (GGSN) 132 in communication with a Serving GPRS Support Node (SGSN) 134 and the MIH server 150. The GGSN 132 is also connected to the Internet (not depicted). The Home Location Register (HLR) 104 is in communication with the MSC 124 and may also be in communication with the MIH server 150. The MSC 124 and SGSN 134 are connected to Radio Network Controller (RNC) 102, which is in communication with Universal Mobile Telecommunications System (UMTS) Radio Access Network (UTRAN) base station 170. UTRAN base station 170 includes at least one processor 176 in communication with a wireless transceiver (Tx/Rx) 172, and antenna 174.

PS network 110 includes a gateway 112 that is in communication with a router 114 and the MIH server 150. The router 114 is in communication with PS base station 160. PS base station 160 includes at least one processor 166 in communication with wireless transceiver 162 and antenna 164. The PS network 110 maybe, by way of example, a network based on IEEE 802.11x, IEEE 802.16x, or other appropriate technology.

The WTRU 180 includes at least one processor 186 in communication with a first transceiver 182 and first antenna 184. The first transceiver 182 and first antenna 184 are configurable to send data to and receive data from the PS base station 160 via a first radio access technology (RAT) implemented by the PS base station 160. The at least one processor 186 of the WTRU is additionally in communication with a second transceiver 192 and second antenna 194. The second transceiver 192 and second antenna 194 are configurable to send data to and receive data from the UTRAN base station 170 via a second RAT implemented by the UTRAN base station 170. The WTRU 180 includes an MIH Function (MIHF) and may communicate with the MIH server 150 via the PS base station 160 and/or the UTRAN base station 170. The WTRU 180 may be capable of communicating with both transceivers 182, 192 simultaneously, or may be capable of only communicating with one of the transceivers 182, 192 at a time. The WTRU 180 may also include additional transceivers (not depicted) in communication with the at least one processor 186 for communicating according to additional diverse RATs. Alternatively or additionally, the WTRU 180 may include one or more multi-mode transceivers (not depicted) in communication with the at least one processor 186, each multi-mode transceiver capable of communicating using more than one RAT.

Each of the UMTS/UTRAN network nodes (UTRAN base station 170, RNC 102, SGSN 134, GGSN 132, MSC 124, GMSC 122, and HLR 104) and PS network 110 network nodes (PS base station 160, router 114, and gateway 112) are functional entities within their respective networks. The MIH server 150 may be implemented as an element in the PS network 110, UMTS core network 108, as a component in another network (not depicted), or as independent of any one specific network. The MIH server 150 may communicate with the other network nodes 170, 102, 134, 132, 124, 122, 104, 160, 114, 112 at layer three or above using IP and/or other protocols, via the Internet and/or other networks. Each network node 170, 102, 134, 132, 124, 122, 104, 160, 114, 112, 150 may be implemented as one or more dedicated network node devices, or any combination of the network nodes 170, 102, 134, 132, 124, 122, 104, 160, 114, 112, 150 may be deployed in any appropriate combination of network node devices. Each network node device may include one or more specific-purpose processors, general purpose processors, software modules, or combinations thereof (not depicted), configured to implement the functionality of a node or combination of nodes. Each network node device may include one or more memory devices (not depicted). Each network node device may include one or more communication interfaces (not depicted) such as wired or wireless transceivers or transmitter/receiver pairs, configurable to communicate with peer network node devices. The communication interfaces may be based on technologies such as Ethernet, Carrier Ethernet, fiber optics, microwave, xDSL (Digital Subscriber Line), Asynchronous Transfer Mode, (ATM), Signaling System 7 (SS7), Internet Protocol (IP), and IP/Multiprotocol Label Switching (MPLS).

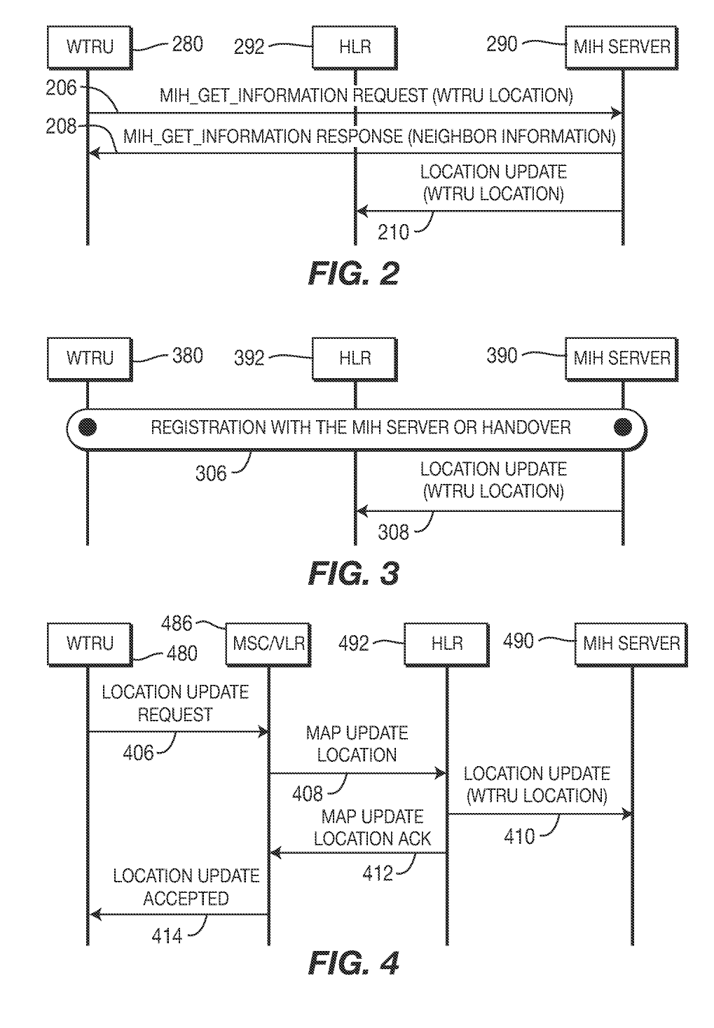

The network architecture of FIG. 1 is capable of supporting the methods described in further detail hereafter with reference to FIGS. 2-7. The network architecture of FIG. 1 is provided purely by way of an example and various other architectures and communication technologies may be used, mutatis mutandis, for implementing the methods of FIGS. 2-7.

FIG. 2 shows a first method for the communication of location information between an HLR 292 and an MIH server 290. The WTRU 280 sends 206 an MIH_Get_Information.request message to the MIH server 290. The MIH_Get_Information.request message includes one or more fields indicating location information related to the WTRU 280. If the MIH server 290 maintains a database of WTRU location information, it modifies the database according to the information received in the MIH_Get_Information.request message by adding or updating one or more entries in the database related to the WTRU. The MIH server 290 sends 208 an MIH_Get_Information.response message to the WTRU 280 including information related to access networks neighboring the WTRU 280. In response to the MIH_Get_Information.request message, the MIH server 290 sends 210 a location update message to the HLR 292 based on the location information received in the MIH_Get_Information.request message. The location update message may also include information related to the current access network of the WTRU 280. The HLR 292 then modifies its location area database by adding or updating one or more entries in the database related to the WTRU according to the information received in the location update.

FIG. 3 shows a second method for the communication of location information between an HLR 392 and an MIH server 390. The WTRU 380 registers 306 with the MIH server 390, or the WTRU 380 and MIH server 390 perform 306 a handover procedure whereby the WTRU 380 is handed over between access networks. In response to the registration or handover, the MIH server 390 sends 308 a location update message to the HLR 392. The location update message may include location information related to the WTRU 380, and/or may include information related to the current access network of the WTRU 380. The HLR 392 then modifies its location area database according to the information received in the location update message.

FIG. 4 shows a third method for the communication of location information between an HLR 492 and an MIH server 490. The WTRU 480 sends 406 a location update request message to the MSC/Visitor Location Register (VLR) 486. The MSC/VLR 486 sends 408 a Mobile Application Part (MAP) Update Location message to the HLR 492, indicating a location of the WTRU 480. In response to the MAP Update Location message, the HLR 492 sends 410 a location update message to the MIH server 490, indicating the current location of the WTRU 480. The location update message may also include information related to the current access network of the WTRU 480. If the MIH server 490 maintains a database of WTRU location information, it may modify the database according to the information received in the location update message. The HLR 492 sends 412 a MAP Update Location Acknowledgement message to the MSC/VLR 486. In response to the MAP Update Location Acknowledgement message, the MSC/VLR 486 sends 414 a location update accepted message to the WTRU 480.

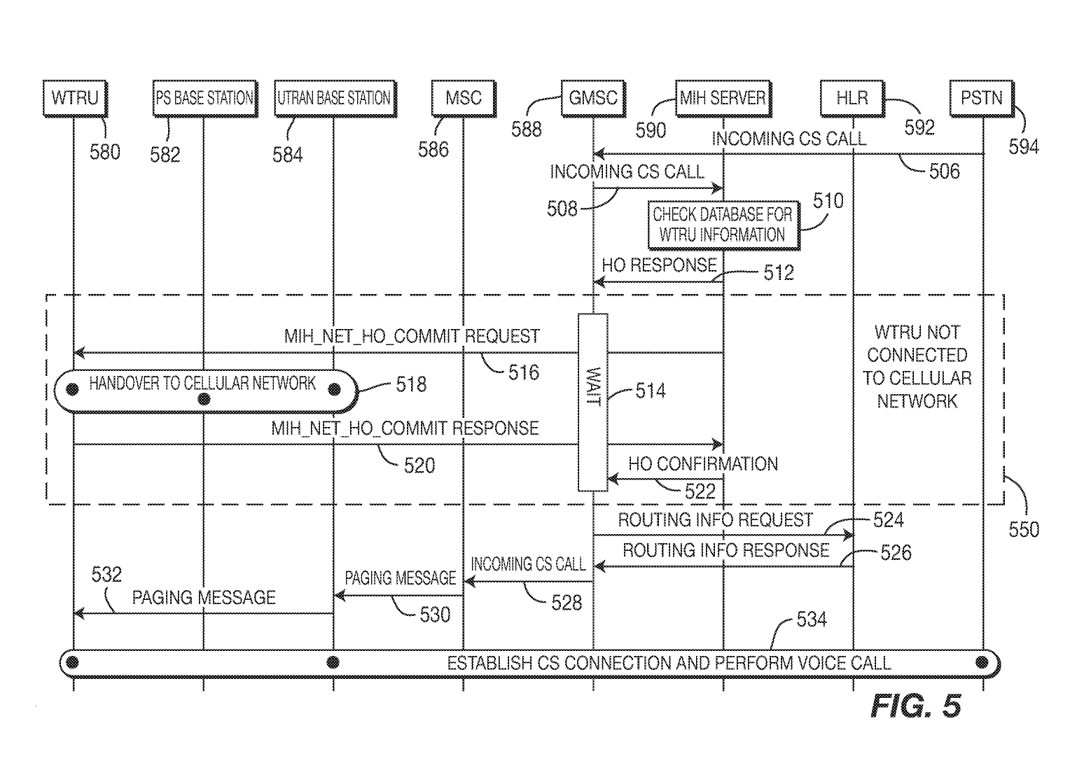

In various implementations, one or any combination of the methods of FIGS. 2-4 may be used to improve the reliability and timeliness of location data used by an MIH server and/or a HLR to perform their respective MIH and HLR functionalities. An MIH server, for example, may use the location information in making handover determinations. A HLR may provide location data base on location information provided by an MIH server. Alternatively or additionally, the methods of FIGS. 2-4 may be used to facilitate handover of a WTRU to receive CS calls, as described in further detail hereafter in FIGS. 5-7.

FIG. 5 shows a method for terminating a CS call at a WTRU 580, wherein a GMSC 588 communicates with an MIH server 590 to handover the WTRU 580 to a UMTS network to receive the call. Before the method of FIG. 5 begins, the WTRU 580 attaches to an access network provided by PS base station 582, registers with the MIH server 590, and receives PS services via the PS base station 582.

The PSTN 594 sends 506 a message to the GMSC 588 indicating an incoming call destined for the WTRU 580. The message sent by the PSTN 594 may be an SS7 Integrated Services Digital Network (ISDN) User Part (ISUP) Initial Address Message (IAM). The GMSC 588 sends 508 a message to the MIH server 590 indicating the incoming call for the WTRU 580. The message indicating the incoming call from the GMSC 588 may indicate a subscriber ID associated with the WTRU 580, and/or may contain information identifying the target UMTS network. The MIH server 590 then checks 510 its local database for information regarding whether the WTRU 580 is currently connected to the UMTS network. The MIH server 590 may maintain a database of access network information for the WTRU 580 as well as additional MIH-capable WTRUs (not depicted). The database may indicate whether the WTRU 580 is currently connected to the UMTS network. If the WTRU 580 is not connected, the MIH server 590 will determine that the WTRU 580 needs to be handed over to the UMTS network. The MIH server 590 sends 512 a handover (HO) response message to the GMSC 588 indicating whether the WTRU 580 will be handed over to UMTS network. The handover response message may indicate that a handover is required, or may indicate that the CS call should proceed without handover. The handover response message may indicate a subscriber ID associated with the WTRU 580.

In an instance where the WTRU 580 will be handed over to the UMTS network, the actions in block 550 are performed. The GMSC 588 determines that the WTRU 580 will be handed over based on the handover response message, and enters a waiting state 514 and does not directly proceed to alert the WTRU 580 to the call. The MIH server 590 sends 516 an MIH_Net_HO_Commit.request message to the WTRU 580 via the PS base station 582, indicating that the WTRU 580 should hand over to the UMTS network. In response to the MIH_Net_HO_Commit.request message, the WTRU 580, PS base station 582, and UTRAN base station 584 perform 518 a handover of the WTRU 580 to the UMTS network. The WTRU 580 then sends 520 an MIH_Net_HO_Commit.response message to the MIH server 590, indicating successful completion of the handover. The MIH_Net_HO_Commit.response message may include one or more fields with information related to the paging message. In response to the MIH_Net_HO_Commit.response message, the MIH server 590 sends 522 a handover confirmation message to the GMSC 588 indicating the successful handover. In response to the handover confirmation message, the GMSC 588 exits the waiting state 514.

In an instance where the actions of block 550 are performed, the GMSC 588 sends 524 a routing information request message to the HLR 592 in response to the handover confirmation message sent 522 by the MIH server 590. In an instance where the actions of block 550 are not performed, the GMSC 588 sends 524 the routing information request message to the HLR 592 in response to the handover response message sent 512 by the MIH server 590. The routing information request message sent 524 by the GMSC 588 may be a MAP Send Routing Information (SRI) message. The HLR 592 sends 526 a routing information response message to the GMSC 588. This routing information response message may be a MAP SRI message.

In response to the routing information response message, the GMSC 588 sends 528 a message to the MSC 586 indicating the incoming CS call. The message sent 528 by the GMSC 588 may be an ISUP IAM message. The MSC 586 sends 530 a paging message to the UTRAN base station 584. This may be performed by the MSC 586 sending 530 a Radio Access Network Application Part (RANAP) paging message to an RNC (not depicted), which then communicates the paging information to the UTRAN base station 584. The UTRAN base station 584 transmits 532 a paging message to the WTRU 580, indicating the call for the WTRU 580. The paging message may be a Radio Resource Control (RRC) paging message. A CS connection is then established 534 at the WTRU 580, and the WTRU 580, UTRAN base station 584, and PSTN 594 perform 534 the CS call.

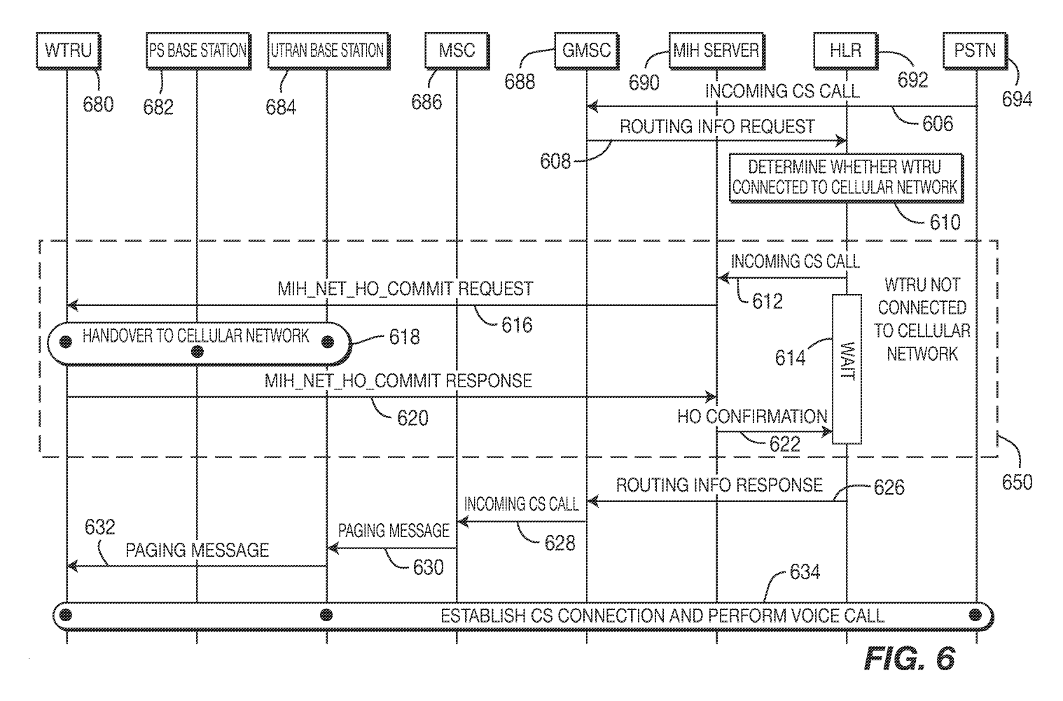

FIG. 6 shows a method for terminating a CS call at a WTRU 680, wherein an HLR 692 in a UMTS network communicates with an MIH server 690 to handover the WTRU 680 to the UMTS network to receive the call. Before the method of FIG. 6 begins, the WTRU 680 attaches to an access network provided by PS base station 682, registers with the MIH server 690, and receives PS services via the PS base station 682.

The PSTN 694 sends 606 a message to the GMSC 688 indicating an incoming call destined for the WTRU 680. The message sent by the PSTN 694 may be an ISUP IAM message. The GMSC 688 sends 608 a routing information request message to the HLR 692. The routing information request message may indicate the incoming CS call for the WTRU. The routing information request message may be, for example, a MAP SRI message. The HLR 692 then determines 610 whether the WTRU 680 is connected to the UMTS network. This determination may be based on location information obtained through standard HLR location update procedures, and/or based on information received by the HLR 692 according to one or any combination of the methods described above with reference to FIGS. 2-4.

In an instance where the WTRU is not connected to the UMTS network, the actions in block 650 are performed. The HLR 692 sends 612 a message to the MIH server 690 indicating the incoming CS call for the WTRU 680. The message indicating the incoming call from the HLR 692 may indicate a subscriber ID associated with the WTRU 680, and/or may contain information identifying the target UMTS network. The HLR 692 enters into waiting state 614 and does not directly proceed to send a response message to the routing information request message. The MIH server 690 sends 616 an MIH_Net_HO_Commit.request message to the WTRU 680 via the PS base station 682, indicating that the WTRU 680 should hand over to the UMTS network. In response to the MIH_Net_HO_Commit.request message, the WTRU 680, PS base station 682, and UTRAN base station 684 perform 618 a handover of the WTRU 680 to the UMTS network. The WTRU 680 then sends 620 an MIH_Net_HO_Commit.response message to the MIH server 690, indicating successful completion of the handover. In response to the MIH_Net_HO_Commit.response message, the MIH server 690 sends 622 a handover confirmation message to the HLR 692 indicating the successful handover. In response to the handover confirmation message, the HLR 692 exits the waiting state 614.

In an instance where the actions of block 650 are performed (where the WTRU 680 was not connected to the UMTS network), the HLR 692 sends 626 a routing information response message to the GMSC 688 in response to the handover confirmation message sent 622 by the MIH server 690. In an instance where the actions of block 650 are not performed (because the WTRU 680 was connected to the UMTS network), the HLR 692 sends 626 a routing information response message to the GMSC 688 in response to the determination 610 that the WTRU 680 was connected to the UMTS network. The routing information response message may be a MAP SRI message.

In response to the routing information response message, the GMSC 688 sends 628 a message to the MSC 686 indicating the incoming CS call. The message sent 628 by the GMSC 688 may be an ISUP IAM message. The MSC 686 sends 630 a paging message to the UTRAN base station 684. This may be performed by the MSC 686 sending 630 a RANAP paging message to an RNC (not depicted), which then communicates the paging information to the UTRAN base station 684. The UTRAN base station 684 transmits 632 a paging message to the WTRU 680, indicating the call for the WTRU 680. The paging message may be a Radio Resource Control (RRC) paging message. A CS connection is then established 634 at the WTRU 680, and the WTRU 680, UTRAN base station 684, and PSTN 694 perform 634 the CS call.

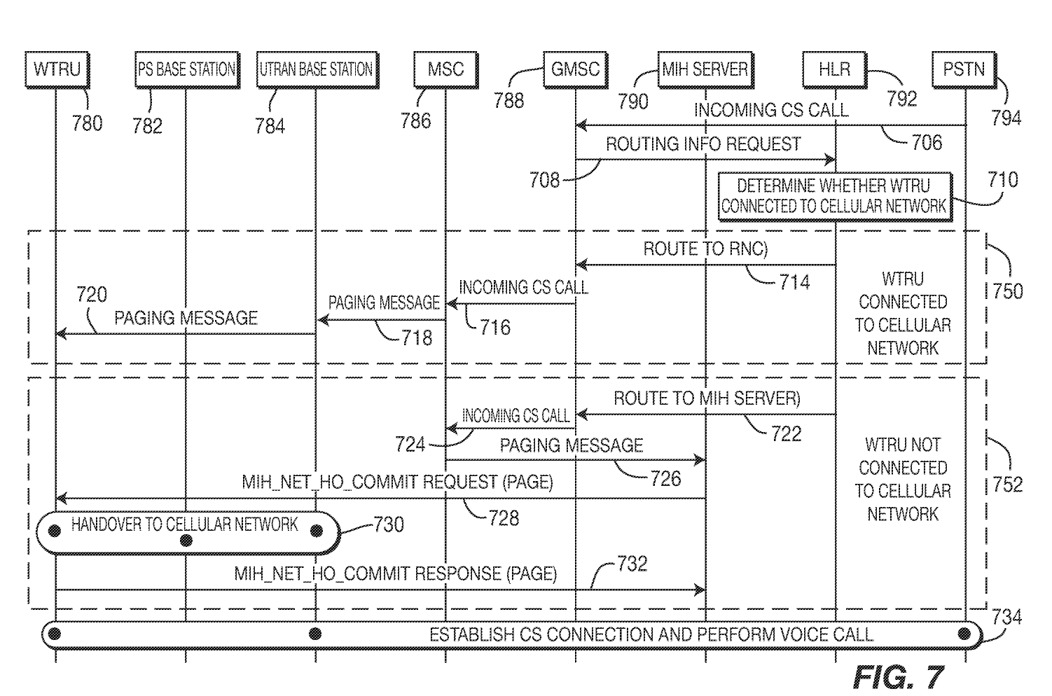

FIG. 7 shows a method for terminating a CS call at a WTRU 780, wherein an MIH server 790 adds paging information to an MIH message to page the WTRU 780 to receive the call in a UMTS network. Before the method of FIG. 7 begins, the WTRU 780 attaches to an access network provided by PS base station 782, registers with the MIH server 790, and receives PS services via the PS base station 782.

The PSTN 794 sends 706 a message to the GMSC 788 indicating an incoming call destined for the WTRU 780. The message sent by the PSTN 794 may be an ISUP IAM message. The GMSC 788 sends 708 a routing information request message to the HLR 792. The routing information request message may be, for example, a MAP SRI message. The HLR 792 then determines 710 whether the WTRU 780 is connected to the UMTS network. This determination may be based on location information obtained through standard HLR location update procedures, and/or based on information received by the HLR 792 according to one or any combination of the methods described above with reference to FIGS. 2-4.

In an instance where the WTRU 780 is connected to the UMTS network, the actions of block 750 are performed. As the WTRU 780 is already connected to the UMTS network, no handover is required. The HLR 792 sends 714 a routing information response message to the GMSC 788 indicating that the call should be routed through the RNC (not depicted) controlling the UTRAN base station 784. The routing information response message may be a MAP SRI message. In response to the routing information response message, the GMSC 788 sends 716 a message to the MSC 786 indicating the incoming CS call. The message sent 716 by the GMSC 788 may be an ISUP IAM message. The MSC 786 sends 718 a paging message to the UTRAN base station 784. This may be performed by the MSC 786 sending 718 a RANAP paging message to the RNC controlling the UTRAN base station 784, which then communicates the paging information to the UTRAN base station 784. The UTRAN base station 784 transmits 720 a paging message to the WTRU 780, indicating the call for the WTRU 780. The paging message may be a Radio Resource Control (RRC) paging message. A CS connection is then established 734 at the WTRU 780, and the WTRU 780, UTRAN base station 784, and PSTN 794 perform 734 the call.

In an instance where the WTRU 780 is not connected to the UMTS network, the actions of block 752 are performed. The HLR 792 sends 722 a routing information response message to the GMSC 788 indicating that the call should be routed through the MIH server 790 as if the MIH server 790 were an RNC. The routing information response message may be a MAP SRI message. In response to the routing information response message, the GMSC 788 sends 724 a message to the MSC 786 indicating the incoming CS call. The message sent 724 by the GMSC 788 may be an ISUP IAM message. The MSC 786 then sends 726 a paging message to the MIH server 790, in the same way that the MSC 786 would ordinarily send a paging message to an RNC. The paging message sent 726 by the MSC 786 may be a RANAP paging message. In response to the paging message, the MIH server 790 sends 728 an MIH_Net_HO_Commit.request message to the WTRU 780 via the PS base station 782, indicating that the WTRU 780 should hand over to the UMTS network and including a paging information. The MIH server 790 may encapsulate the paging message in the MIH_Net_HO_Commit.request message, may reformat one or more fields from the paging message and include the reformatted paging information in one or more fields in the MIH_Net_HO_Commit.request message, and/or may generate the MIH_Net_HO_Commit.request message to include an indicator field indicating that the MIH_Net_HO_Commit.request message relates to a page. In response to the MIH_Net_HO_Commit.request message, the WTRU 780, PS base station 782, and UTRAN base station 784 perform 730 a handover of the WTRU 780 to the UMTS network. After the WTRU 780 is connected to the UMTS network, the WTRU 780 may respond to the page (not depicted) in the UMTS network. To accomplish this, the MIHF at the WTRU 780 that receives the MIH_Net_HO_Commit.request message may pass the paging information to the Non-Access Stratum (NAS) layer in the UTRAN stack in the WTRU 780. The WTRU 780 may additionally perform a routing area update procedure prior to responding to the page in the UMTS network. In response to successful handover, the WTRU 780 sends 732 an MIH_Net_HO_Commit.response message to the MIH server 790, indicating successful completion of the handover and including a paging indicator. The WTRU 780 then establishes 734 a CS connection, and the WTRU 780, UTRAN base station 784, and PSTN 794 perform 734 the CS call.

At any point during the methods shown in FIGS. 5-7, a WTRU 580, 680, 780 may provide an indication to the user such as, for example, a sound and/or displayed graphic or text, informing the user of the incoming call and/or that an MIH-based handover to a CS domain is taking place. In response to the indication, the user may choose to wait for the CS connection to be established, hang up on the call, or send the call to voice mail. In some instances, it is possible that the incoming call will be terminated by the caller before the CS connection can be established at the WTRU 580, 680, 780. In such an instance, the WTRU 580, 680, 780 may inform the user (via, for example, sound and/or displayed graphics or text) of the missed call. The user may choose to use this information to return the call. In an instance where the incoming call is not initially established, PS sessions that are also being handed over should not be affected so long as the handover is ultimately successfully performed. If a handover is performed but the call is not initially established, the WTRU 580, 680, 780 may continue PS sessions via the transferred-to UTRAN, or may be handed back over to the PS network. A determination as to whether the WTRU 580, 680, 780 should stay in the UTRAN or return to the PS network may be based on MIH handover policy, a profile associated with the WTRU 580, 680, 780, and/or other information.

Referring back to FIG. 1, network nodes 170, 102, 134, 132, 124, 122, 104, 160, 114, 112, 150 and WTRU 180 are configurable to perform the signaling described above with reference to FIGS. 2-7. Processors in the network nodes 170, 102, 134, 132, 124, 122, 104, 160, 114, 112, 150 and WTRU 180 are configurable to generate and process messages and signals as described above with reference to FIGS. 2-7. One or more transceivers in WTRU 180 are configurable to send and receive messages and signals as described above with reference to FIGS. 2-7. Communication interfaces in the network nodes 170, 102, 134, 132, 124, 122, 104, 160, 114, 112, 150 and WTRU 180 are configurable to send and receive messages and signals as described above with reference to FIGS. 2-7.

Although FIGS. 2-7 include an example UTRAN/UMTS network, networks of other types may be substituted for the example UTRAN/UMTS network, mutatis mutandis, without departing from the principles described above with reference to FIGS. 2-7. Suitable networks include a Global System for Mobile Communications (GSM) EDGE Radio Access Network (GERAN) network, a Code Division Multiple Access (CDMA) 2000 network, and other networks that includes a CS domain and a PS domain.

Although features and elements are described above with reference to FIGS. 1-7 in particular combinations, each feature or element can be used alone without the other features and elements or in various combinations with or without other features and elements. The sub-elements of the methods and features described above with reference to FIGS. 1-7 may be realized in any arbitrary order (including concurrently), in any combination or sub-combination. Sub-elements described with reference to any single FIGURE may be used in combination with the sub-elements described with reference to any other Figure or combination of other Figures. The methods or flow charts provided herein may be implemented in one or more computer programs, software, or firmware incorporated in a computer-readable storage medium for execution by a general purpose computer or one or more processors.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

### Embodiments

1. A method for use in wireless communications, the method comprising:

a WTRU communicating with an MIH server; and

the MIH server communicating with an HLR.

2. The method of embodiment 1 further comprising:

the MIH server receiving an MIH message from the WTRU, the MIH message including location information related to the WTRU;

the MIH server sending a message to the HLR, the message including the location information related to the WTRU; and

the HLR modifying a database based on the received location information.

3. The method of embodiment 2 wherein the message sent by the MIH server to the HLR includes information related a current access network of the WTRU.

4. The method of any one of embodiments 2-3 wherein the message received by the MIH server from the WTRU is an MIH_Get_Information.request message.

5. The method of any one of embodiments 1-4 further comprising:

the WTRU registering with the MIH server;

in response to the registration, the MIH server sending a message to the HLR, the message including location information related to the WTRU; and

in response to the message, the HLR modifying a database based on the received location information.

6. The method of any one of embodiments 1-5 further comprising:

the MIH server and the WTRU handing over the WTRU between access networks;

in response to the handover, the MIH server sending a message to the HLR, the message including location information related to the WTRU; and

in response to the message, the HLR modifying a database based on the received location information.

7. The method of any one of embodiments 1-6 further comprising:

the WTRU sending a location update request message to a MSC/VLR;

in response to the location update request message, the MSC/VLR sending a MAP Update Location message to the HLR, the MAP Update Location message including location information related to the WTRU;

in response to the MAP Update Location message, the HLR sending a location update message to the MIH server, the location update message including the location information related to the WTRU; and

the MIH server HLR modifying a database based on the received location information.

8. The method of embodiment 7 further comprising:

the HLR sending a MAP Update Location Acknowledgement message to the MSC/VLR; and

in response to the MAP Update Location Acknowledgement message, the MSC/VLR sending a location update accepted message to the WTRU.

9. A method for use in wireless communications, the method comprising:

a GMSC receiving a message indicating an incoming CS call for a WTRU in a cellular network.

10. The method of embodiment 9 further comprising:

in response to the message indicating the incoming CS call for the WTRU, the GMSC sending a message to an MIH server indicating the incoming CS call for the WTRU; and

the MIH server determining whether the WTRU is connected to the cellular network.

11. The method of embodiment 10 further comprising:

in response to a determination that WTRU is not connected to the cellular network, the MIH server sending a handover response message to the GSMC indicating that the WTRU will be handed over to the cellular network;

the MIH server sending an MIH handover request message to the WTRU via a PS network, the MIH handover request message indicating that the WTRU should hand over to the cellular network;

in response to the MIH handover request message, the WTRU performing a handover to the cellular network;

in response to the handover, the WTRU sending an MIH handover complete message to the MIH server; and

in response to the MIH handover confirmation message, the MIH server sending a handover confirmation message to the GMSC indicating the successful handover; and

in response to the handover confirmation message, the GMSC sending a routing information request message to an HLR.

12. The method of embodiment 11 wherein the MIH handover request message is a MIH_Net_HO_Commit.request message.

13. The method of any one of embodiments 11-12 wherein the MIH handover complete message is an MIH_Net_HO_Commit.response message.

14. The method of any one of embodiments 10-13 further comprising:

in response to a determination that WTRU is not connected to the cellular network, the MIH server sending a handover response message to the GSMC indicating that the WTRU will not be handed over to the cellular network;

in response to the handover response message, the GMSC sending a routing information request message to the HLR.

15. The method of any one of embodiments 10-14 further comprising:

in response to the routing information request message, the HLR sending a routing information response message to the GMSC;

in response to the routing information response message, the GMSC sending a message to an MSC indicating the incoming CS call;

in response to the message indicating the incoming CS call, the MSC sending a paging message to an RNC or a base station controller (BSC);

the RNC or BSC sending a paging message to the WTRU; and

the WTRU establishing a CS connection in the cellular network and receiving the incoming CS call.

16. The method of any one of embodiments 9-15 further comprising:

in response to the message indicating the incoming CS call for the WTRU, the GMSC sending a routing information request message to an HLR; and

the HLR determining whether the WTRU is connected to the cellular network.

17. The method of embodiment 16 further comprising:

in response to a determination by the HLR that the WTRU is not connected to the cellular network, the HLR sending a message to an MIH server indicating the incoming CS call for the WTRU; and

in response to the message from the HLR, the MIH server sending an MIH handover request message to the WTRU indicating that the WTRU should hand over to the cellular network;

in response to MIH message, the WTRU handing over to the cellular network;

in response to the handover, the WTRU sending an MIH handover complete message to the MIH server;

in response to the handover complete message, the MIH server sending a handover confirmation message to the HLR; and

in response to the handover confirmation message, the HLR sending a routing information response message to the GMSC.

18. The method of embodiment 17 wherein the MIH handover request message is a MIH_Net_HO_Commit.request message.

19. The method of any one of embodiments 17-18 wherein the MIH handover complete message is an MIH_Net_HO_Commit.response message.

20. The method of any one of embodiments 17-19 further comprising:

in response to a determination by the HLR that the WTRU is not connected to the cellular network, the HLR sending a routing information response message to the GMSC.

21. The method of any one of embodiments 16-20, further comprising:

in response to a determination by the HLR that the WTRU is connected to the cellular network, the HLR sending a routing information response message to the GMSC, the routing information response message indicating that the CS call should be routed to the WTRU via a RNC or BSC;

in response to the routing information response message, the GMSC sending a message to an MSC indicating the incoming CS call;

in response to the message indicating the incoming CS call, the MSC sending a paging message to the RNC or BSC;

the RNC or BSC sending a paging message to the WTRU; and

the WTRU establishing a CS connection in the cellular network and receiving the incoming CS call.

22. The method of any one of embodiments 20-21, further comprising:

in response to a determination by the HLR that the WTRU is not connected to the cellular network, the HLR sending a routing information response message to the GMSC, the routing information response message indicating that the CS call should be routed to the WTRU via an MIH server;

in response to the routing information response message, the GMSC sending a message to an MSC indicating the incoming CS call;

in response to the message indicating the incoming CS call, the MSC sending a paging message to the MIH server;

in response to the paging message, the MIH server sending an MIH handover request message to the WTRU, the MIH handover request message indicating that the WTRU should hand over to the cellular network and including paging information;

in response to the MIH handover request message, the WTRU handing over to the cellular network;

in response to the handover, the WTRU sending an MIH handover complete message to the MIH server;

in response to the handover, the WTRU establishing a CS connection in the cellular network and receiving the incoming CS call.

23. The method of embodiment 22 wherein the MIH handover request message is a MIH_Net_HO_Commit.request message.

24. The method of any one of embodiments 22-23 wherein the MIH handover complete message is an MIH_Net_HO_Commit.response message.

25. The method of any one of embodiments 9-24 further comprising:

the WTRU indicating the incoming CS call to a user.

26. The method of any one of embodiments 9-25 further comprising: the WTRU indicating to a user that an MIH-based handover to a CS domain is in progress.

27. A method comprising the method of any one of embodiments 1-8 and

the method of any one of embodiments 9-26.

28. A WTRU configured to implement at least a portion of the method of any one of embodiments 1-27.

29. The WTRU of embodiment 28, wherein the WTRU comprises at least one processor in communication with at least one transceiver, the at least one transceiver capable of communicating using two or more RATs.

30. A network node configured to implement at least a portion of the method of any one of embodiments 1-27.

31. The network node of embodiment 30 wherein the network node is configured to implement at least one of: base station functionality; RNC functionality; BSC functionality; GGSN functionality; SGSN functionality; MSC functionality; GMSC functionality; HLR functionality; MIH server functionality; Packet Data Gateway (PDG) functionality; PS network gateway functionality; and PS network router functionality.

32. The network node of any one of embodiments 30-31 wherein the network node comprises at least one processor in communication with at least one communication interface.

33. A wireless communication system configured to implement the method of any one of embodiments 1-27.

34. A wireless communication system comprising the WTRU of any one of embodiments 28-29 and the network node of any one of embodiments 30-32.

35. The wireless communication system of embodiment 34 wherein the WTRU and/or the network node implement at least one of: IEEE 802.11x; WiMax; Wireless Broadband (WiBro); IEEE 802.16m; CDMA2000; GSM; GERAN; UMTS; UTRAN; Wideband Code Division Multiple Access (WCDMA); Long Term Evolution (LTE); Evolved (E-UTRAN); and LTE-Advanced.

What is claimed is:

1-25. (canceled)

26. A Home Location Register (HLR), the HLR comprising:
a communication interface configured:
to receive a first message from a Gateway Mobile Switching Center (GMSC) in a cellular network, the first message requesting routing information related to a wireless transmit/receive unit (WTRU) and indicating an incoming circuit-switched (CS) call for the WTRU; and
on a condition that the WTRU is not connected to the cellular network, to send a second message to a Media Independent Handover (MIH) server indicating the incoming CS call for the WTRU.

27. The HLR of claim 26 wherein the communication interface is further configured to receive location information associated with the WTRU from the MIH server, the HLR further comprising:
at least one processor configured to modify a location information database according to the location information associated with the WTRU.

28. The HLR of claim 26 wherein the communication interface is further configured to transmit location information associated with the WTRU to the MIH server.

29. The HLR of claim 26 wherein the communication interface is further configured:
to receive a handover confirmation message from the MIH server indicating that the WTRU has performed a handover to the cellular network; and
in response to the handover confirmation message, to send a routing information response message to the GMSC.

30. A Media Independent Handover (MIH) server, the MIH server comprising:
a communication interface configured:
to receive a message from a Home Location Register (HLR) indicating an incoming circuit-switched (CS) call for a wireless transmit/receive unit (WTRU) in a cellular network; and
in response to the message from the HLR, to send an MIH_Net_HO_Commit.request message to the WTRU indicating that the WTRU shall perform a handover to the cellular network.

31. The MIH server of claim 30 wherein the communication interface is further configured to send location information associated with the WTRU to the HLR.

32. The MIH server of claim 30 wherein the communication interface is further configured to receive location information associated with the WTRU from the HLR, the MIH server further comprising:
at least one processor configured to modify a location information database according to the location information associated with the WTRU.

33. The MIH server of claim 30 wherein the communication interface is further configured:
to receive an MIH_Net_HO_Commit.response message from the WTRU, wherein the MIH_Net_HO_Commit.response message indicates a successful handover of the WTRU to the cellular network.

34. The MIH server of claim 30 wherein the communication interface is further configured to send a handover confirmation message to the HLR in response to the MIH_Net_HO_Commit.response message.

35. A wireless transmit/receive unit (WTRU), the WTRU comprising:
at least one transceiver configured:
to receive a first Media Independent Handover (MIH) message from an MIH server, the first MIH message including paging information related to an incoming circuit-switched (CS) call in a cellular network for the WTRU; and
to perform a handover of the WTRU to the cellular network in response to the first MIH message.

36. The WTRU of claim 35 wherein the first MIH message is an MIH_Net_HO_Commit.request message.

37. The WTRU of claim 35 wherein the at least one transceiver is configured to receive the first MIH message via an IEEE 802.11x or IEEE 802.16x network.

38. The WTRU of claim 35 wherein the at least one transceiver is further configured:
in response to a successful completion of the handover, to send a second MIH message to the MIH server; and
to receive the incoming CS call in the cellular network.

39. The WTRU of claim 38 wherein the second MIH message is an MIH_Net_HO_Commit.response message.

40. The WTRU of claim 38 wherein the at least one transceiver is configured to send the second MIH message via a Global System for Mobile Communications (GSM) EDGE Radio Access Network (GERAN), a Universal Mobile Telecommunications System (UMTS) Radio Access Network (UTRAN), or a Code Division Multiple Access (CDMA) 2000 network.
